(19) United States
(12) Patent Application Publication
(10) Pub. No.: US 2010/0117537 A1
(43) Pub. Date: May 13, 2010

(54) ILLUMINATING ARRANGEMENT IN CONNECTION WITH A TEXTILE STRUCTURE

(75) Inventors: Matti Horppu, Siikainen (FI); Esa Kivioja, Honkajoki (FI)

Correspondence Address: VENABLE LLP, P.O. BOX 34385, WASHINGTON, DC, 20043-9998, US

(73) Assignees: NEULE-APU OY, Siikainen (FI); KKK-VIHANNES OY, Honkajoki (FI)

(21) Appl. No.: 12/597,378

(22) PCT Filed: Mar. 20, 2008
(86) PCT No.: PCT/FI08/50132

§ 371 Date: Oct. 23, 2009

(30) Foreign Application Priority Data
Apr. 23, 2007 (FI) 20070313

(51) Int. Cl. H01K 7/00

(52) U.S. Cl. 315/76

(57) ABSTRACT

An illuminating arrangement in connection with a textile structure. The illuminating arrangement includes an electric wire system engaging a machine-fabricated textile structure. The electric wire system includes electrical components electrically coupled therewith and providing at least an illuminating function, which are located in a longitudinal and/or lateral direction of the textile structure at a distance from each other for creating an essentially reticulated lighting effect, and a control and power supply system for operating the electrical components. An electrical wire system of the illuminating arrangement includes a substantially flat circuit-board technology based wire element comprising said electrical components and with a wrapper element for all-round protection. The wire element is integrated within a knitted textile fabric structure with an inlay technique using machine knitting.

The invention relates to an illuminating arrangement, said illuminating arrangement comprising an electric wire system disposed in engagement with a machine-fabricated textile structure, said electric wire system including electrical components electrically coupled therewith and providing at least an illuminating function, such as LEDs or the like, which are located in the textile structure's longitudinal and/or lateral direction at a distance from each other for creating an essentially reticulated lighting effect, and a control and power supply system for operating the electrical components.

In the above context, it is prior known to use a lighting system of the type disclosed e.g. in the German application publication DE 10 2004 050 838 A1, wherein a woven textile structure is provided with electrically conductive weft or warp yarns, having LEDs coupled therewith for activating the same by means of a power supply system provided in engagement with the textile structure. Proposed applications for such an illuminated textile structure include e.g. clothing, furniture, interior decorating, and advertising industries. The LEDs included in the lighting system are capable of being pre-connected to the electrically conductive weft or warp yarns or else capable of being set in a finished fabric structure afterwards.

Consistent with the type of implementation and intended application of the above-cited solution, such a solution is highly inconvenient in terms of implementing the electrical couplings included therein in a way to eliminate the occurrence of leakage currents and thereby malfunctions, especially as a result of moisture. Thus, the discussed solution is only suitable for indoor use in dry conditions.

On the other hand, Finnish patent No. 108106 discloses a method for the fabrication of a wire element, and a wire element which consists at least of an electrically conductive elongated wire member, in which are inserted a plurality of longitudinally successive electrical components capable of providing e.g. a guiding function consistent with an intended application of the wire element. In addition, the assembly consisting of a wire member and components present therein is covered with a protective wrapper member. The wire element is fabricated from a substantially flat wire member, such as a ribbon, a strip or the like, an electrically conductive layer included therein, manufactured by a so-called circuit board technique, being fitted with electrical components, such as sensors, LEDs, resistances and/or the like, by adapting it through the use of a continuous manufacturing process, such as extrusion or the like, to provide most preferably, as viewed in cross-section, an all-integral assembly with a wrapper material constituting the wrapper member.

The above-described solution has enabled implementing a highly integrated, versatile and functionally reliable wire element, which is capable of being utilized, as such, also in humid conditions. However, this type of wire element, as such, does not lend itself to the use in weaving because of the wire element's structural rigidity which is excessive from the standpoint of weaving.

An illuminating arrangement according to the present invention, capable of being used in connection with a textile structure, has an objective of providing a decisive improvement for the above-discussed problems and of thereby raising substantially the existing state of the art, particularly in terms of implementations useful in humid conditions. In order to accomplish this objective, an illuminating arrangement according to the invention is primarily characterized in that the illuminating arrangement, which is particularly useful in humid conditions, such as intended for growing plants, has its electric wire system, first of all, made up of a substantially flat and so-called circuit-board technology based wire element, which has been provided during its manufacturing process with said electrical components and with a wrapper element for its all-round protection. On the other hand, said wire element is integrated within a knitted textile fabric structure by means of inlay technique using machine knitting.

The most important benefits gained by an illuminating arrangement according to the invention, which is useful in humid conditions, should be mentioned to include the simplicity and operating reliability of its construction, operation, and assembly resulting therefrom, especially in humid conditions, which is primarily accomplished by virtue of a so-called circuit-board technology based, moisture-proofed wire element. On the other hand, a knitted fabric used in association therewith enables using therein a per se rather rigid wire element of the above-described type as an inlay member. Moreover, the wire system in an illuminating arrangement of the invention enables readily the use of e.g. light, light regulating, illumination regulating elements, moisture and temperature detection and control sensors, as well as growth monitoring sensors, especially in plant growing applications by virtue of the fact that the discussed components are capable of being coupled with the wire element as early as during its manufacturing process in a totally moisture-proofed fashion. Consequently, the illuminating arrangement according to the invention is capable of being used e.g. for the artificial lighting of growing vegetations, for the regulation of natural light for the same, for gathering information regarding the growing conditions and growth of plants, and for controlling the growing conditions. On the other hand, the invention lends itself also to the lighting of and the regulation of conditions in most diversified other similar spaces. The invention further enables the implementation of assemblies of most diversified flexibility characteristics by using a knitted fabric most appropriate for a specific application.

Other preferred embodiments for an illuminating arrangement of the invention, capable of being used in connection with a textile structure, are presented in dependent claims directed thereto.

The invention will be explained in detail in the following description with reference to the accompanying drawings, in which

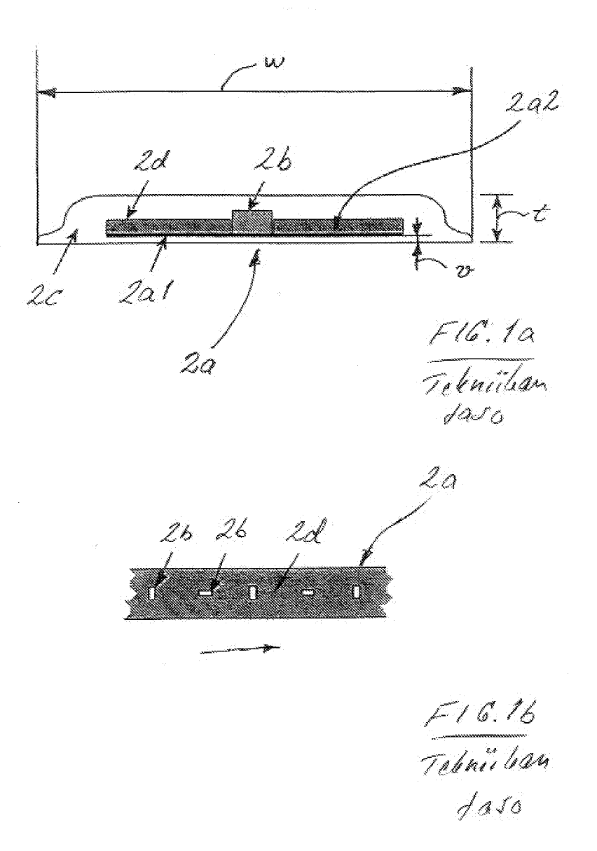

FIGS. 1a and 1b illustrate one preferred wire element, compatible with an illuminating arrangement of the invention, in a cross-sectional view, and its internal configuration in an overhead view,

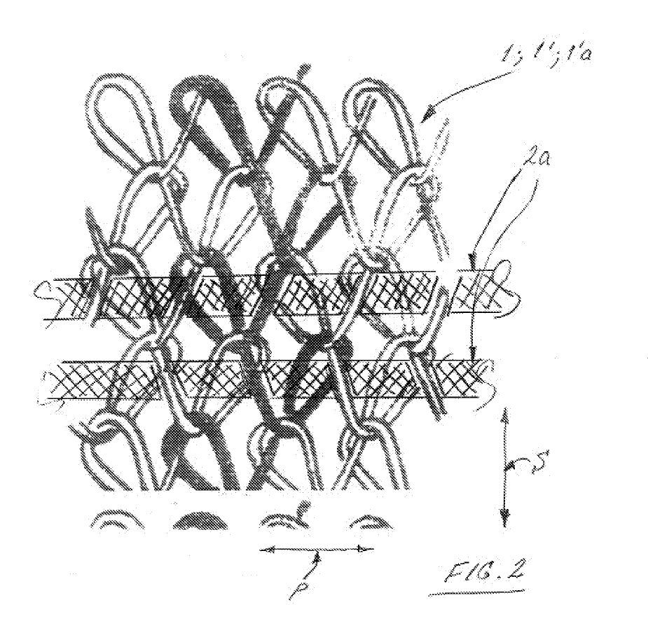

FIG. 2 illustrates one preferred illuminating arrangement of the invention in a standard warp knitted fabric, wherein the inlay wire element is provided in the form of a weft inlay element,

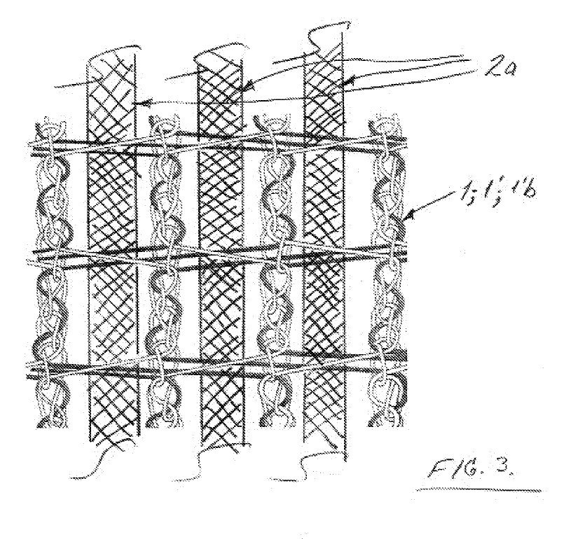

FIG. 3 illustrates another alternative embodiment, wherein the inlay wire element is present as a warp inlay component in a warp knitted mesh fabric structure,

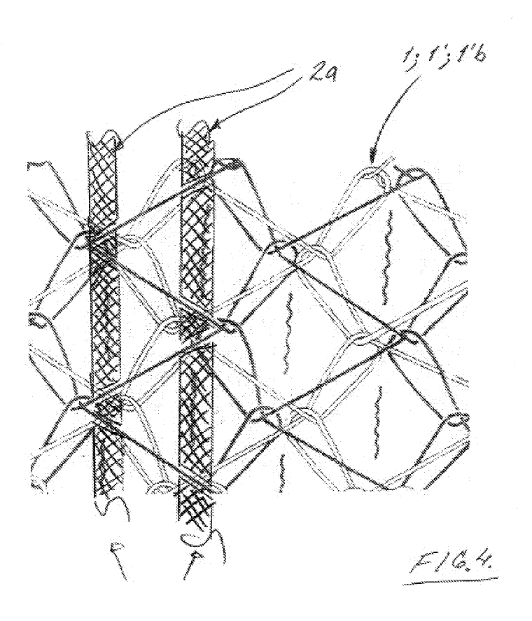

FIG. 4 illustrates another preferred alternative embodiment, wherein the inlay wire element is present as a warp inlay component in a warp knitted mesh fabric structure different from the one shown in FIG. 3,

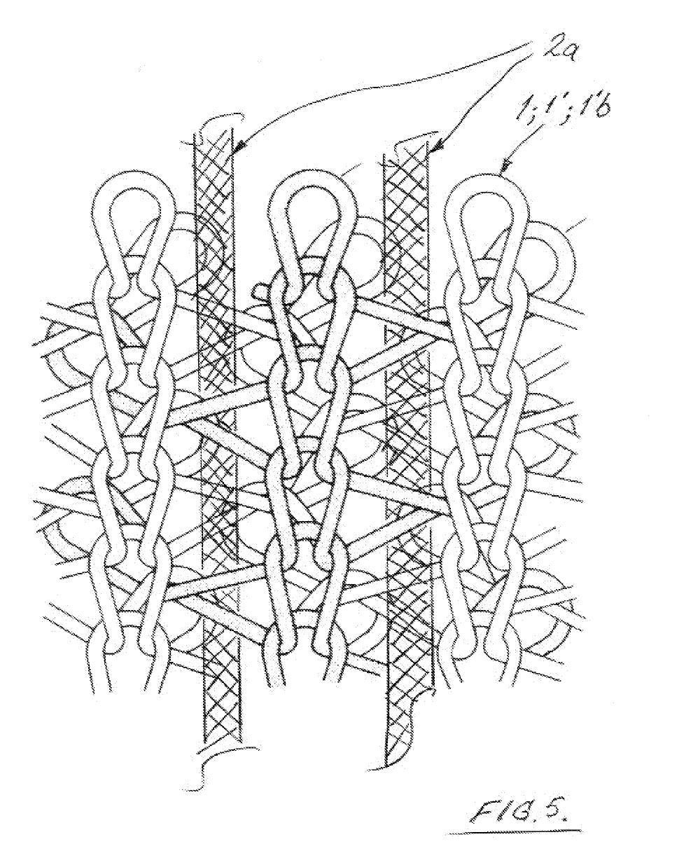

FIG. 5 illustrates a further preferred alternative embodiment, wherein the inlay wire element is present as a warp inlay component in a warp knitted fabric structure knitted with two sets of needles,

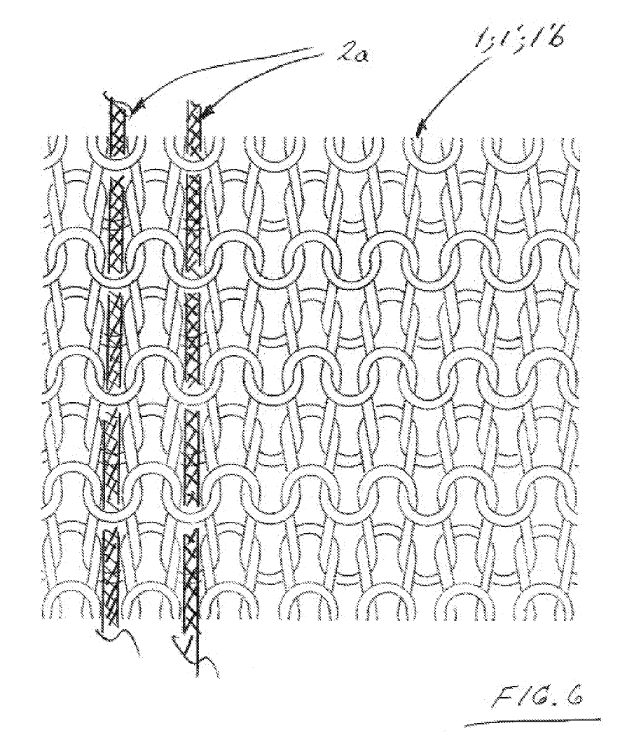

FIG. 6 illustrates one preferred alternative embodiment, wherein the inlay wire element is present as a warp inlay component in a links-links weft knitted fabric,

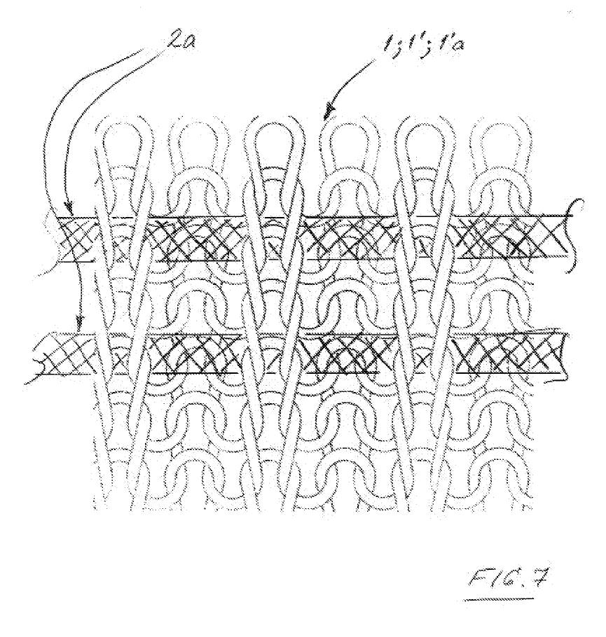

FIG. 7 illustrates another preferred alternative embodiment, wherein the inlay wire element is present as a weft inlay component in a 1×1 rib knit (weft knitted fabric),

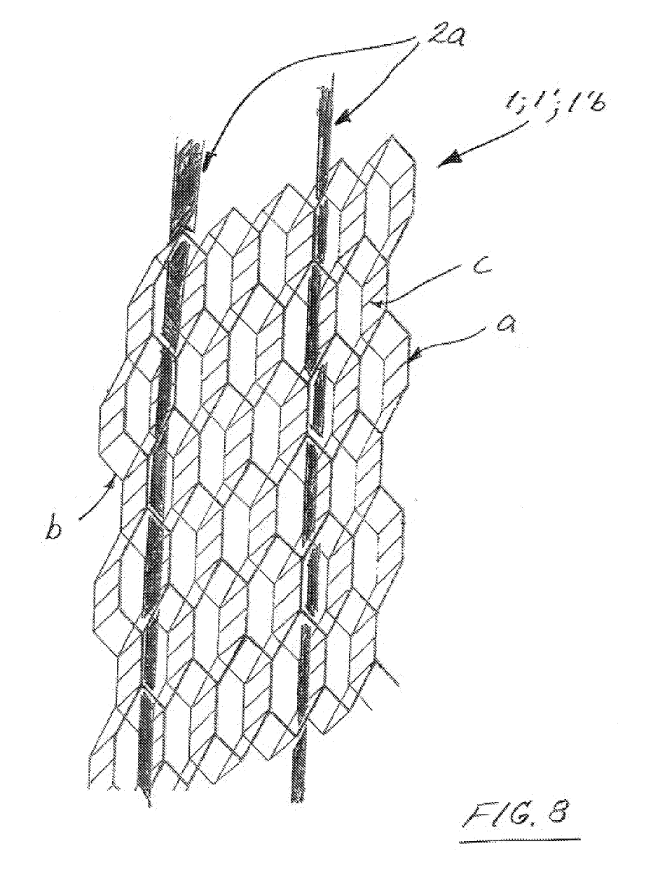

FIG. 8 illustrates one preferred alternative embodiment, wherein the inlay wire element is present as a warp inlay component in a spacer-mesh warp knitted fabric,

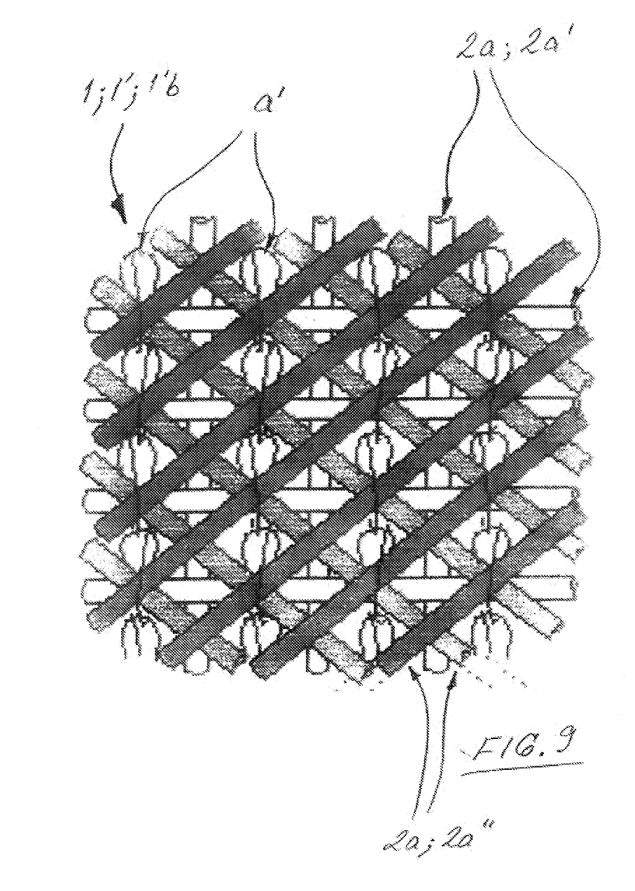

FIG. 9 illustrates another preferred alternative embodiment, wherein the inlay wire elements are present as weft and warp inlay components and as cross-inlay components in a multi-axial warp knitted fabric, and

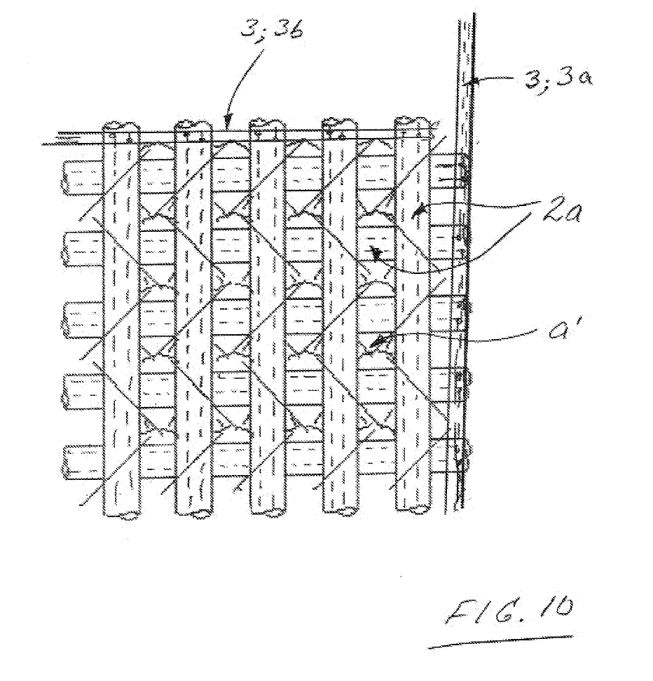

FIG. 10 illustrates an exemplary view of one exemplary control and/or power supply system for an illuminating arrangement of the invention.

The invention relates to an illuminating arrangement in connection with a textile structure, said illuminating arrangement comprising an electric wire system 2 disposed in engagement with a machine-fabricated textile structure 1, said electric wire system including electrical components electrically coupled therewith and providing at least an illuminating function, such as LEDs or the like, which are located in the textile structure's longitudinal s and/or lateral p direction at a distance from each other for creating an essentially reticulated lighting effect, and a control and power supply system for operating the electrical components. The illuminating arrangement, which is particularly useful in humid conditions, such as intended for growing plants, has its electric wire system, first of all, made up of a substantially flat and so-called circuit-board technology based wire element 2a, such as a ribbon, a string or the like of electric wire, which has been provided during its manufacturing process with said electrical components 2b and with a wrapper element 2c for its all-round protection. On the other hand, said wire element is integrated within a knitted textile fabric structure 1; 1′ by means of inlay technique using machine knitting.

In particular reference to a preferred embodiment shown in FIGS. 1a and 1b, said electrical components 2b are mounted, preferably by surface-mounting technique, on an electrically conductive layer 2a2, lining a plastic-based, such as a polyamide-, polyester- or the like manufactured base material 2a1 of the wire element 2a enabling at least a dynamic operation, and extending in a continuous manner substantially over its length, which assembly is completely covered with a plastic-, such as pvc-, olefin-based and/or the like wrapper material 2c by using a continuous manufacturing process, such as extrusion or the like. In addition, the embodiment shown in FIGS. 1a and 1b is provided with a skin layer 2d covering a top surface of the wire element 2a. As a preferred embodiment in this context, the wire elements 2a are coupled with a control and power supply system 3, such as one or more electricity conducting lines 3a and/or 3b, connected in engagement with the knitted fabric structure 1; 1′ by means of moisture-protected bayonet couplings, as presented e.g. in FIG. 10. This enables ensuring an optimal operation of the illuminating arrangement in humid conditions, whereby, for example, the replacement of a single wire element is an easy procedure e.g. by plugging a new wire element to the rear end of a wire element to be replaced, followed by pulling it inside the knitted fabric structure by means of the wire element to be replaced, once it has been first released from the control and power supply line. Respectively, the electricity conducting lines are readily replaceable by virtue of bayonet couplings in case of possible faults.

In a preferred embodiment of the invention, the knitted fabric structure 1; 1′ associated with the illuminating arrangement comprises a weft inlay fabric 1′a. A few such fabrics are illustrated by way of example in FIGS. 2 and 7. In a further preferred embodiment of the invention, the knitted fabric structure 1; 1′ associated with the illuminating arrangement comprises a warp inlay fabric 1′b, some of which are in turn illustrated by way of example in FIGS. 3-6 and 8.

In a further preferred embodiment of the invention, the knitted fabric structure 1; 1′ associated with the illuminating arrangement comprises, in particular reference to FIG. 9, a multiaxially warp-knitted inlay fabric 1′b, whereby, in the configuration shown by way of example in the discussed figure, reference character a′ represents a standard warp knit, reference character 2a; 2a′ represents a weft and/or warp inlay component included optionally in the knitted fabric structure for the transmission of light and/or information, and, furthermore, reference character 2a; 2a″ represents a diagonal or cross-inlay component included therein for the transmission of light and/or information.

In a further preferred embodiment of the invention, especially in view of growing and exposing plants to light, the wire element's 2a electrical components 2b comprise measuring sensors for monitoring at least temperature, humidity, color, and/or light.

Accordingly, the knitted fabric structure 1; 1′ associated with the illuminating arrangement may, in reference to the accompanying drawings, consist of a standard crosslinked structure, a mesh structure, and/or a multilayer structure such as a spacer fabric or mesh, which has been depicted particularly in FIG. 8. In FIG. 8, reference character a represents a standard warp fabric knitted with a front bed needle set, b represents a standard warp fabric knitted with a back bed needle set, and c represents a spacer yarn present between the front bed and back bed needle sets.

In a further preferred embodiment of the invention, 8 the knitted fabric structure 1; 1′ associated with the illuminating arrangement comprises a polymer-based textile mesh, having engaged in connection therewith, such as with one or more outer edges, a control and/or power supply system 3 in an integrated manner, as shown e.g. in FIG. 10, whereby the knitted fabric includes electricity conducting lines 3a and/or 3b for warp and/or weft components. In this figure, reference character a′ represents a standard warp knit.

In a further preferred embodiment of the invention, the material of the knitted fabric structure 1; 1′ associated with the illuminating arrangement comprises a yarn produced from staple or filament fibers by spinning and/or a ribbon produced from sheet or film by cutting.

In a further preferred embodiment of the invention, the illuminating arrangement has been adapted to provide illumination on both sides of the knitted fabric structure 1; 1′ by arranging at least some of the electric wire system's coinciding inlay wire elements 2a in a back-to-back relationship, at least some of the electric wire system's laterally or longitudinally offset inlay wire elements 2a to provide illumination in opposite directions, and/or in the like manner.

The above-described solution is intended to be particularly useful in growing plants, whereby a necessary number of illuminating elements, such as e.g. LEDs, coupled with a continuously extending wire element, are integrated by a totally machine-operated fabrication technique within a mesh-like textile structure so as to provide an illumination which is bilateral relative thereto. According to what is pointed out above, the power supply and control needed for the illumination is also possible to be integrated in engagement with the mesh structure. It is possible that a so-called light curtain, implemented in accordance with the invention, be installed e.g. by suspending it from a ceiling between plant rows for illuminating and exposing the plants to light from lateral directions by a so-called inter-exposure. If necessary, the height of a light curtain implemented as described is e.g. only about a meter, whereby it illuminates all the time just the area which is optimal for the plants. If necessary, it is also possible to provide the light curtain with auxiliary equipment, enabling e.g. raising or rolling it up, e.g. in a motor-driven manner, which enables the attending staff to perform other procedures for the plants.

Generally speaking, regarding the above-described service, the light curtain realized according to the invention, as regards its most preferred qualities and form, must be:
moisture and pressure wash resistant
corrosion resistant
light transmitting, it must not screen the plants
heat resistant, it must not, in itself, provide too much heating, either
capable of being rolled or raised up
UV light resistant
air permeable
easy to install and maintain
environmentally sound and energy efficient (recyclability and reuse)
consistent with standards and occupational safety regulations.

Furthermore, a preferred light curtain comes with a possibility of providing vertical control over the luminosity of the LEDs. On the other hand, another possibility of implementing the light curtain is to effect the regulation and control of illumination by means of a simple user interface and by providing the light curtain with electric properties to keep it effective over its entire service life.

For example, modern polymer materials provide a convenient source for producing textiles capable of withstanding the above-mentioned stresses. In addition, modern technology enables technical features required by an illuminating arrangement of the invention to be easily integrated with textile structures.

At the moment there is already available a wire element, originally manufactured for guide and safety lighting, which is made of a pliable rubber-coated material with a thickness t of e.g. about 2 mm and a width w of about 25 mm, having its back surface also provided with a thin protective layer v. Such a wire element 2a, for example, is totally specifiable to match the intended application (among other things, power, control of LEDs individually, LEDs of various colors, aiming of light and optics). The discussed wire element's safety classification is IP 68, which is adequate especially for growing plants as the standard for greenhouse facilities stipulates a safety classification of at least IP 44. The discussed wire element is also excellent in terms of its temperature resistance (−40 to +150° C.), which is why an implementation of this type, for example, is as such applicable for use as an element integrable with a light curtain of the invention and also elsewhere with greenhouse structures.

Electrical supply systems in more sophisticated LED systems are nowadays, almost without exception, network-connected, microprocessor-controlled chopper devices, which are readily integrable also with greenhouse facilities to be renovated. In the process of carrying out the present invention, special attention must be paid to mating and boundary surfaces between the control and power supply line and the wire elements 2a integrated within a knitted fabric structure, in addition to whose tightness and protection against corrosion, it is necessary to make sure of the ability to perform service and maintenance procedures therefor promptly and easily by using e.g. moisture-protected bayonet couplings.

In view of maximizing the energy and lighting efficiency, it is preferred that the exposure to light can be regulated as desired. In practice, this means, for example, that the lighting can be regulated e.g. in a row-specific manner according to the time of day and various seasons. In addition to this, the illumination provided by a light curtain can be preferably controlled also vertically or most desirably even in matrices, whereby the overall lighting of a greenhouse would be specifiable as required by the demand of lighting in given operating conditions. With this type of illumination it is possible to make sure that no dissipated extra light will be produced. Another possible requirement is the ability to regulate the illumination in terms of its the red and blue light ratio in various stages of plant growing, which is thus a point to be considered in the process of designing electrical elements included in the wire element.

In principle, the illumination lends itself to be controlled e.g. by means of a suitable automated bus-type application or by some other equivalent, e.g. address-based system. Naturally, it is most convenient that the illumination control, performed by the actual end user, be carried out from a computer or other appropriate terminal e.g. by means of a simple graphical user interface.

With regard to safety at work, LEDs are excellent in terms of their mechanical function, operating at low voltage. Consequently, hazardous contact voltages cannot develop, even if the assembly configured according to the invention should become damaged for some reason. As far as luminosity is concerned, e.g. the occupational safety regulations in Finland and the European indoor lighting standard SFS-EN 12464 only state that lighting at the workplace must be adequate in view of the nature of work. The lighting level required for working in greenhouse environment must be at least 200 lux. These standards provide also specifications regarding glare limitation, which may become an issue especially with LED lamps, but also with high-pressure sodium vapor discharge lamps. The discussed light sources, namely, have a luminance or surface brightness which considerably exceeds that of fluorescent lamps and workers may find this disturbing. The luminance of LEDs, in particular, is on such a level that it must not be allowed a direct access to the eyes of a viewer as the powerful light may damage ophthalmic sensory cells. In the context of LEDs, further attention must be paid to the fact that the ophthalmic retina is most vulnerable to short-wave or blue light, even though the human eye is not at its most sensitive within this range.

Normally, during the maintenance and attendance of vegetations, the lighting is switched off and the curtain is rolled up for facilitating the work.

1. An illuminating arrangement in connection with a textile structure, said illuminating arrangement comprising:
an electric wire system disposed in engagement with a machine-fabricated textile structure, said electric wire system including electrical components electrically coupled therewith and providing at least an illuminating function in a longitudinal and/or lateral direction of a structure of the textile at a distance from each other for creating an essentially reticulated lighting effect,
a control and power supply system for operating the electrical components, and
an electric wire system comprising a substantially flat circuit-board technology based wire element comprising said electrical components and comprising a wrapper element for all-round protection, and wherein said wire element is integrated within a knitted textile fabric structure with an inlay technique using machine knitting.

2. The illuminating arrangement according to claim 1, wherein said electrical components are mounted on an electrically conductive layer, lining a plastic-based manufactured base material of the wire element enabling at least a dynamic operation, and extending in a continuous manner substantially over a length of the wire element, wherein the electrical components and the electrically conductive layer are completely covered with a wrapper material and wherein the wire elements are coupled with a control and power supply line connected in engagement with the knitted fabric structure by moisture-protected bayonet couplings.

3. The illuminating arrangement according to claim 1, wherein the knitted fabric structure associated therewith comprises a weft inlay fabric.

4. The illuminating arrangement according to claim 1, wherein the knitted fabric structure associated therewith comprises a warp inlay fabric.

5. The illuminating arrangement according to claim 1, wherein the knitted fabric structure associated therewith comprises a multiaxially knitted inlay fabric.

6. The illuminating arrangement according to claim 1, wherein the electrical components further comprise measuring sensors for monitoring at least temperature, humidity, color, and/or light.

7. The illuminating arrangement according to claim 1, wherein the knitted fabric structure associated therewith comprises a crosslinked structure, a mesh structure, and/or a multilayer structure.

8. The illuminating arrangement according to claim 1, wherein the knitted fabric structure associated therewith comprises a polymer-based textile mesh, having engaged in connection therewith a control and/or power supply system.

9. The illuminating arrangement according to claim 1, wherein the material of the knitted fabric structure associated therewith comprises a yarn produced from staple or filament fibers by spinning and/or a ribbon produced from sheet or film by cutting.

10. The illuminating arrangement according to claim 1, wherein the illuminating arrangement is adapted to provide illumination on both sides of the knitted fabric structure by arranging at least some of the coinciding inlay wire elements of the electric wire system in a back-to-back relationship, at least some of the laterally or longitudinally offset inlay wire elements of the electric wire system to provide illumination in opposite directions.
